(19) United States
(12) Patent Application Publication
(10) Pub. No.: US 2021/0160669 A1
(43) Pub. Date: May 27, 2021

(54) WIRELESS ON BOARD VEHICLE SYSTEM FOR VEHICLE TO VEHCILE COMMUNICATION

(71) Applicant: Bobin George, San Antonio, TX (US)

(72) Inventor: Bobin George, San Antonio, TX (US)

(21) Appl. No.: 16/697,688

(22) Filed: Nov. 27, 2019

(51) Int. Cl. H04W 4/46; B60W 60/00; G08G 1/01; G08G 1/0967; G07C 5/08; G07C 5/00

(52) U.S. Cl. CPC H04W 4/46; B60W 60/0027; G07C 5/008; G08G 1/096725; G07C 5/085; G08G 1/0112

(57) ABSTRACT

A method is provided to connect existing traditional vehicles to an A.I neural network. Upon sensing another electronic device within range, the two wireless systems can now communicate on an intranet. Communication can also occur between the OBD (onboard device) device and autonomous vehicles, smart signs, and other compatible devices. Communication links may happen through WIFI, cellular, or Bluetooth

### BACKGROUND

This generally relates to a mobile electronic equipment that connects a traditional vehicle (non-autonomous) to a network. The onboard device or (OBD) will transmit data packets to the autonomous car that will help the A.I with situational awareness with non-A.I objects.

Today there is advancements in A.I technology. A.I. technology depends on sensors, and other data such as GPS to ensure that the car is operating in the intended manner. However, GPS is easily manipulated. Also, todays autonomous car developers utilize LIDAR for situational awareness, but LIDAR it self is prone to attacks as hackers can project objects in the road that are not there.

Therefore a method to improve situational awareness for the autonomous vehicle will enhance the safety of the public would be desirable.

### SUMMARY

Vehicles will be provided with an Onboard device that has capabilities to transmit and receive data packets to nearby devices in the intranet. The OBD once connected to the Vehicle via the vehicle's CANbus interface will be able to relay information to autonomous networks, and other databases. Data can be transmitted using Blue Tooth, Cellular, or device antenna.

Each vehicle will contain one onboard device. The onboard device shall be in proximity to the vehicles onboard computer (OBD2)

Each message that is transmitted by the OBD will contain information on the transmitting vehicle. Information such as vehicle speed, OBD private key ID, steering angles, and other data available to the OBD from the OBD2 computer of the vehicle.

GPS and global positing of the vehicle may be included in the messages. Using the GPS positing of the vehicle may be able to allow the OBD of a Vehicle to determine the location and distance of another vehicle equipped with the same OBD device. GPS data may be relayed back to the vehicles in the form waypoints relayed back to a neural network, that relates to autonomous vehicles. Data may be also transmitted back to the drivers in the form of a graphical interface.

Alerts will be sent to the nearby vehicle OBD, and Autonomous vehicles within the intranet. Alerts such as dramatic change in vehicle speed, gas ratio, torque, and other diagnostic information will be relayed to the intranet. These alerts will help the autonomous vehicle drive more safely.

Further features of this invention, and its advantages, will be more apparent accompanying drawings, and the following detailed description of the preferred embodiments.

### BRIEF DESCRIPTION OF THE DRAWINGS

FIG. 1 is a schematic diagram illustrative of the vehicle circuitry with an embodiment of the present invitation

FIG. 2 is a diagram showing how the OBD interacts with other OBD devices on the road. FIG. 2 also shows how communicate between each other so they can create an intranet between themselves

FIG. 3 is a diagram showing the alert that is received by the database and the autonomous vehicles that enhances its situational awareness.

FIG. 4 is a flow chart of the illustrative steps involved in gathering signals such as Bluetooth, GPS or cellular with an embodiment of the present invention.

### DETAILED DESCRIPTION

The vehicle will be provided with an onboard electronic apparatus. The device (0) may be equipped with wireless transceiver circuitry. The device will also have the capabilities to communicate via a connected private network. For example, the device may be having transmitters. By using the transmitters to relay car diagnostic messages, the vehicle is making its presence and location known to nearby OBD systems, and autonomous cars.

The vehicle will be equipped with an electric device that can transmit messages using cellular, WIFI, and Bluetooth. The vehicle may also receive the data from nearby participating vehicles, and the intranet. For example, and autonomous car is traveling on the highway can receive data from the front, back, left and right sides of the vehicle. Received data will be analyzed, and it will enhance situational awareness for an Autonomous car by communicating with an on-board device in the nearby traditional vehicle.

The OBD may wireless transmit data in packets that may contain information to enhance the situational awareness of the autonomous vehicles. The message may include vehicle data such as speed, license plate, owner, insurance information, vehicle. To ensure privacy the sensitive information may be encrypted, and/or partially block or fully block, redacted, or otherwise anonymized.

Receiving networks, or autonomous cars will be receiving data alerting them to the surrounding non-A.I objects. The Autonomous car will be alerted to the speed of the nearby vehicles, and the position. Then by using learning algorithms, the receiving vehicle will determine the position, and best course of action. For example, a network/and or autonomous cars receives data that the non-A. I object will overtake it, therefore the A.I can adjust its speed and course just from the message and data it receives. The Autonomous vehicle could also be alerted that nearby vehicles have come to a halt, and due to the hills obstructing its view the autonomous vehicles on board sensors would not be able to detect a sudden halt. But if the autonomous vehicles are alerted with a message from a OBD of a non A.I object it will be more aware of its situational awareness making the ride safe for the general public.

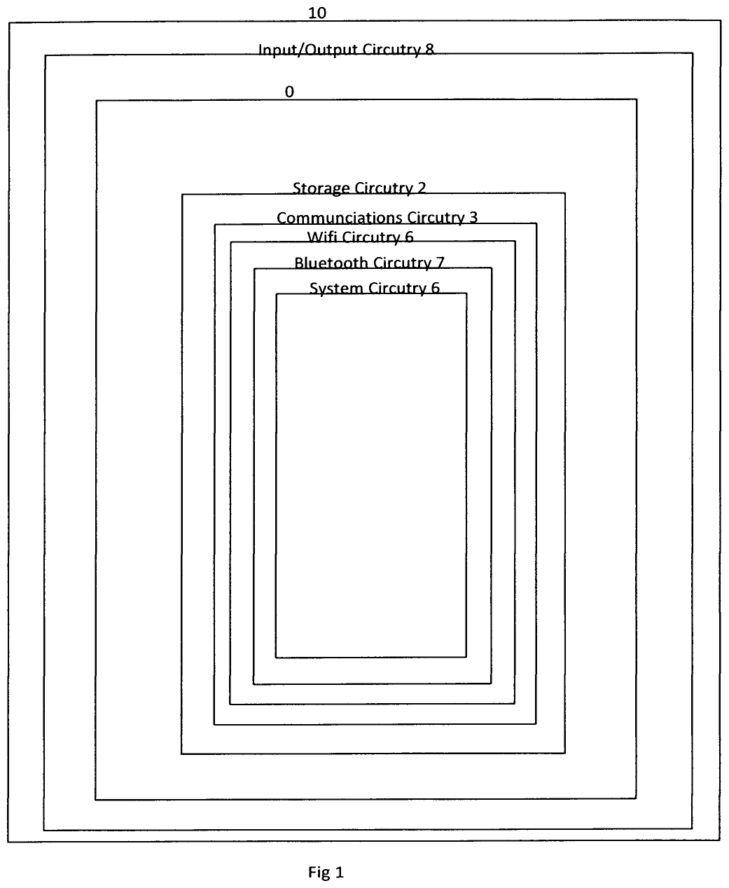

Illustrative electronic equipment of the type that may be used to gather vehicle data, transmit data, and receive nearby vehicles data. FIG. 1. In a typical system an equipment 0 will be used in transmitting and receiving the data. A system may include a mobile piece of device 10 such as an automobile, motorcycle, that is equipped with equipment 0 and it is transmitting signals and receiving signals, and nearby devices that are also transmitting the signals such as vehicles that are transmitting. Each OBD in this system will use some or all of the circuitry of equipment 0 of FIG. 1.

Electronic equipment such as equipment 0 of FIG. 1 may be a vehicle such as an automobile, truck motorcycle, bicycle, ambulance, fire, truck, police car and other emergency services vehicle. Both receiving equipment such as a vehicle being driven may have bi directional capabilities. (I.e. Support transmission of data using known protocols such as Bluetooth.

As shown in FIG. 1, electronic device 0 may include control circuit such as storage and processing circuitry 2. Storage and processing circuitry may include one or more different types of storage such as hard disk drive storage, flash memory, or other electrically-programmable-read-only memory. Circuitry 2 may also include random access memory. Processor circuitry may be based on a processor such as a microprocessors and other suitable integrated units. The Circuitry may be used with an arrangement to run GPS software on the onboard device, and may be used to store GPS data, and other sensory data messages that will be relayed to nearby devices. The circuitry may also be used to control equipment 10, ie processing sensor data, or software for issuing message to the driver, or an autonomous network.

Input output circuitry may be used to transmit data to device 10, and allow data to be provided to device 10. Communications circuitry 3 may induced RF trans ever formed from one or more integrated circuits, antenna's, and or other circuitry for handling RF signals. Circuitry 3 may include wireless, WIFI IEEE 802.11 transceivers circuitry 6, Bluetooth circuitry 7, and satellite system receiver circuitry 5.

input output circuitry may include input out put devices such as sensors input 8, from that are present on device 10. Sensors such as throttle position, battery life, steering Colum position, gas ratio and other common diagnostic information that device 10 may relay to equipment 0.

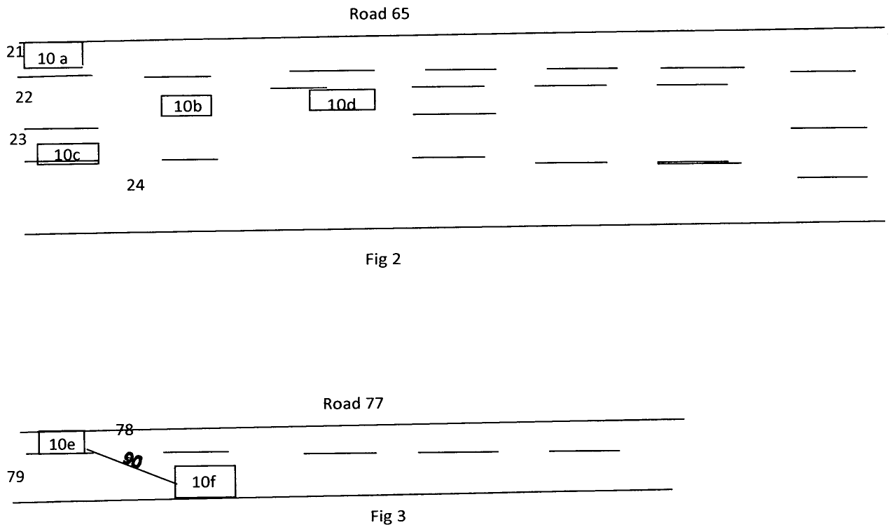

FIG. 2 shows how multiple devices 0 communicate with each other. The system includes multiple different types of equipment 10 and are drivers on the road. The drivers on the road may be equipped with equipment 0 or may be driverless vehicles. This figure is merely illustrative.

Road 65 may include many lanes such as; and 21, 22, 23, 24 on which the vehicles (equipment 10) may be driven. For example, 10(a),10(c),10(d) may be a vehicle that is being driven buy a human being, while 10 b is a car that is autonomous. Equipment 0 will communicate with 10B by transmitting wirelessly its data points. The Autonomous vehicle will now consider the data packets when making its decisions.

Communication circuitry 3 can be used in whole or separately to relay information about the vehicles current state to other nearby devices. Device 0 will also collect the vehicle diagnosis information from device 10 and pass that information to nearby devices.

FIG. 3 consist of a road 77, with lanes 78 and 79. There are two devices 10(f) and 10(e). 10(e) is speeding forward 90, as 10e moves into lane 79 the equipment 0 will capture the data and send it to 10e via 10f. 10e is an autonomous car and it is sent a message to alert it that the car will merge into lane 78. 10f is a car that is on lane 78 which has come to a complete stop and it is on a downward slope. 10e lidar radars cannot see the cars due to an obstruction on its LIDAR. 10f will relay an alert to 10f to make the 10e situationally aware of the car stopped ahead.

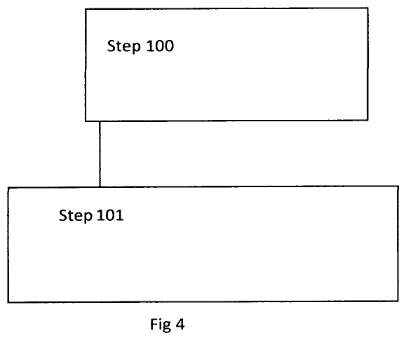

The illustrative steps FIG. 2 and FIG. 3 are shown in FIG. 4. At Step 100 the driver whether autonomous or human. Equipment 0 will monitor the vehicle and start collecting data on device 10. The data will relate to the status of device 10. This data may include but not limited to; information on the vehicle, model, year and make. Whether the vehicle is an emergency vehicle, if the sirens are on, speed of the vehicle, status of the driver, weights.

At step 101 the communications circuitry of device 10 will transmit the data to surrounding devices. During this operation the device may also transmit the GPS signal of the device 10 to alert other devices to the location of the vehicle.

During step 101 the processing circuitry 1 may be used to store, and rank data attributes. The circuitry 1 will also be used to determine other attributes such as GPS, vehicle speed. The circuitry will also encrypt the data and pass it along in an anonymized for to other nearby devices. Circuitry 1 can also be used to determine emergency events such as an airbag deployed.

Examples of actions that may be taken at step 101 include controlling the driver behavior of the autonomous car, presenting alerts and sending the data to an autonomous network server to be shared with other autonomous cars.

1. An apparatus or device that is installed on a non autonomous vehicle that c captures data and sends messages as described above

2. A method for allowing an autonomous vehicle to derive information from an apparatus that is installed on non-autonomous cars. The method compromises of an non autonomous vehicle sending its data to a nearby autonomous cars using the onboard apparatus.

3. The method in which the autonomous vehicle adjusts its trajectory or path after it has received a message from a non autonomous car using the apparatus described above.
